(19) United States
(12) Patent Application Publication
(10) Pub. No.: US 2011/0122853 A1
(43) Pub. Date: May 26, 2011

(54) RADIO COMMUNICATION DEVICE, CONTROL METHOD FOR RADIO COMMUNICATION DEVICE AND PROGRAM STORAGE MEDIUM

(75) Inventors: Tatsuma Hirano, Tokyo (JP); Toshihisa Nabetani, Kawasaki-shi (JP); Ryoko Matsuo, Tokyo (JP); Tomoko Adachi, Tokyo (JP); Kiyoshi Toshimitsu, Tokyo (JP)

(73) Assignee: KABUSHIKI KAISHA TOSHIBA, Minato-ku, Tokyo (JP)

(21) Appl. No.: 12/438,842

(22) PCT Filed: Dec. 18, 2008
(86) PCT No.: PCT/JP2008/073665

§ 371 Date: Feb. 25, 2009

(30) Foreign Application Priority Data
Dec. 26, 2007 (JP) 2007-334736

(51) Int. Cl. H04W 88/02

(52) U.S. Cl. 370/338

(57) ABSTRACT

A radio communication device C1 of the present invention includes a conversion unit 20 configured to convert a first electric wave received by an antenna 10 into a first frame, a determination unit 21 configured to determine whether or not the destination of the first frame is the other radio communication device, an estimation unit 22 configured to estimate the first direction from which the first electric wave has arrived, if it is determined that the destination of the first frame is the other radio communication device, a first prevent unit 30 configured to prevent the transmission of electric wave in the first direction, a prediction unit 40 configured to predict the second direction from which a second electric wave arrives if a second frame is transmitted from a second radio communication device of destination of the first frame to a first radio communication device of source of the first frame over the second electric wave, and a second prevent unit 30 configured to prevent the transmission of electric wave in the second direction.

### TECHNICAL FIELD

The present invention relates to a radio communication device, a control method for the radio communication device, and a program storage medium storing a control program for the radio communication device.

### BACKGROUND ART

The recent radio communication devices employ a space division multiplexing technique for enabling the radio communication with a plurality of radio communication devices with the same frequency at the same time by transmitting the electric wave in a specific direction only from a directional antenna. Such a radio communication device allows the radio communication by transmitting the electric wave in other than the direction to which the radio communication device exists during the radio communication, even though the other radio communication devices are making the radio communication with one another. In a system composed of such radio communication devices, there was a problem that if it is known that the other radio communication devices make the radio communication with one another, NAV (Network Allocation Vector) as specified in IEEE802.11 is set to refrain from transmitting the electric wave in all directions, to avoid collision between radio signals, for example, thereby missing a transmission opportunity.

To solve such problem, a technique for a Directional NAV (DNAV) for setting NAV in each direction has been reported (e.g.,)JP-A 2005-64672 (Kokai)).

With the technique as disclosed in this JP-A 2005-64672 (Kokai), the DNAV is set only in a direction where the radio, communication device exists during the radio communication to refrain from transmitting the electric wave in the direction, and the transmission of electric wave is allowed in the directions where the radio communication device does not exist during the radio communication. Therefore, it is possible to make the radio communication with the radio communication device existing in the direction where the DNAV is not set without obstructing the radio communication between other radio communication devices, even while the other radio communication devices make the radio communication with one another, and effectively utilize the transmission opportunity.

With the technique as disclosed in JP-A 2005-64672 (Kokai), in receiving a radio signal transmitted from one radio communication device A to the other radio communication device B, the DNAV is set only in the direction from which the electric wave arrives, namely, the direction where the radio communication device A exists, to refrain from transmitting the electric wave. Therefore, even if the DNAV is set, it is not possible to refrain from transmitting the electric wave in the direction where the radio communication device B exists, resulting in a problem that the occurrence of collision between the radio signal transmitted in the direction where the radio communication device B exists and the radio signal transmitted from the radio communication device B to the radio communication device A cannot be suppressed in some cases.

This problem becomes more severe in a burst communication in which the transmission of the radio signal is repeated in one direction from the radio communication device A to the radio communication device B, or a communication of the method in which the radio signal to respond is not expected.

### DISCLOSURE OF THE INVENTION

According to an aspect of the present invention, there is provided with a radio communication device communicating by using an antenna, comprising:

an estimation unit configured to estimate a first direction from which a first electric wave has arrived;

a conversion unit configured to convert the first electric wave into a first frame;

a determination unit configured to determine whether or not a destination of the first frame is the radio communication device;

a first prevent unit configured to prevent transmission of electric wave in the first direction when it is determined that the destination of the first frame is a second radio communication device;

a prediction unit configured to predict a second direction from which a second electric wave arrives before a second frame is transmitted with the second electric wave from the second radio communication device which is a destination of the first frame to a first radio communication device which is a source of the first frame; and

a second prevent unit configured to prevent transmission of electric wave in the second direction.

### BRIEF DESCRIPTION OF THE DRAWINGS

FIG. 1 is a diagram showing a radio communication device according to a first embodiment;

FIG. 2 is a diagram showing the positional relationship among the radio communication devices according to the first embodiment;

FIG. 3 is a block diagram showing the configuration of the radio communication device according to the first embodiment;

FIG. 4 is a view showing one example of storage contents of a transmission prevent table storage according to the first embodiment;

FIG. 5 is a flowchart showing the operation of the radio communication device according to the first embodiment;

FIG. 6 is a diagram showing the positional relationship among the radio communication devices according to the first embodiment;

FIG. 7 is a diagram showing the transmission and reception of frame between the radio communication devices and the associated operation according to the first embodiment;

FIG. 8 is a block diagram showing the configuration of a radio communication device according to a second embodiment;

FIG. 9 is a view showing one example of storage contents of an arrival direction storage according to the second embodiment;

FIG. 10 is a diagram showing the positional relationship among the radio communication devices according to the second embodiment;

FIG. 11 is a diagram showing the transmission and reception of frame between the radio communication devices and the associated operation according to the second embodiment;

FIG. 12 is a block diagram showing the configuration of a radio communication device according to a third embodiment;

FIG. 13 is a diagram showing the transmission and reception of frame between the radio communication devices and the associated operation according to the third embodiment;

FIG. 14 is a block diagram showing the configuration of a radio communication device according to a fourth embodiment; and

FIG. 15 is a diagram showing the transmission and reception of frame between the radio communication devices and the associated operation according to the fourth embodiment.

### BEST MODE FOR CARRYING OUT THE INVENTION

The embodiments of the present invention will be described below.

### First Embodiment

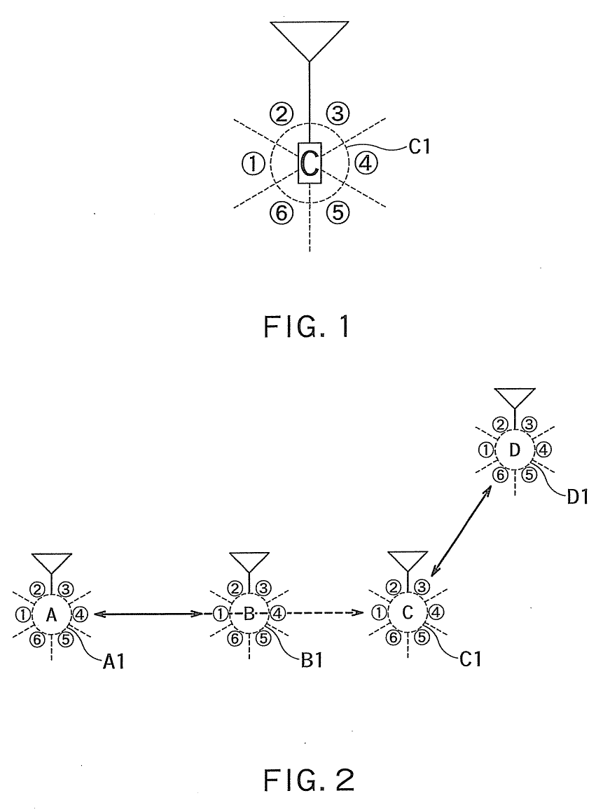

FIG. 1 is a diagram showing a radio communication device C1 according to a first embodiment of the invention.

This radio communication device C1 transmits the electric wave in a specific direction only using a directional antenna. The radio communication device C1 evenly divides the perimeter of a circle around 360 degrees into six radio areas (sectors) of every 60 degrees. The radio communication device C1 transmits the electric wave for each sector. The radio communication device C1 sets up a DNAV (Directional Network Allocation Vector) for each sector, and prevents or cancels the transmission of electric wave for each sector. In the radio communication device C1, the number of sectors is not limited to six. Also, it is unnecessary that the radio communication device C1 evenly divides the perimeter of circle around 360 degrees.

FIG. 2 is a network organization diagram where a set of plural radio communication devices A1, B1, C1 and D1 communicate on the same radio channel. The radio communication devices B1, C1 and D1, like the radio communication device A1, evenly divide the perimeter of circle around 360 degrees into the radio areas (sectors) of every 60 degrees, and make the radio communication for each sector. This radio communication system is composed of a wireless LAN (Local Area Network) conforming to the IEEE802.11 standards, for example.

A set of the radio communication device A1 and the radio communication device B1 and a set of the radio communication device C1 and the radio communication device D1 make the radio communication on the same radio channel.

The radio communication device A1 receives the electric wave from the radio communication device B1 in the fourth direction, and transmits the electric wave to the radio communication device B1 in the fourth direction.

The radio communication device B1 receives the electric wave from the radio communication device A1 in the first direction, and transmits the electric wave to the radio communication device A1 in the first direction.

The radio communication device C1 receives the electric wave from the radio communication device D1 in the third direction, and receives the electric wave from the radio communication device A1 in the first direction. The radio communication device C1 also receives the electric wave from the radio communication device A1 that is not communicated. The radio communication device C1 sets a DNAV to only the sector in the first direction to prevent the transmission of electric wave only in the first direction, and transmits the electric wave to the radio communication device D1 in the third direction.

The radio communication device D1 receives the electric wave from the radio communication device C1 in the sixth direction, and transmits the electric wave to the radio communication device C1 in the sixth direction.

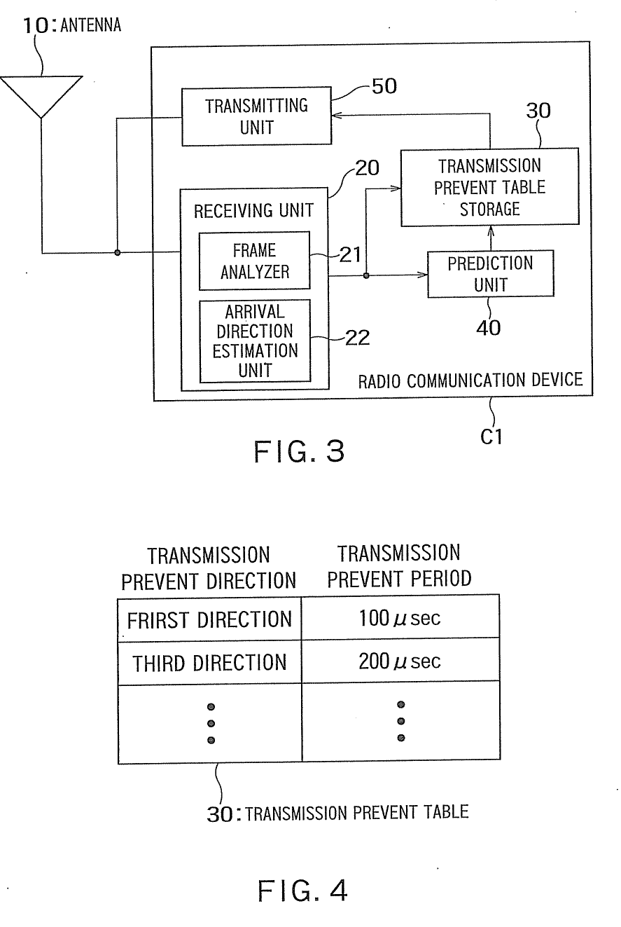

FIG. 3 is a block diagram showing the configuration of the radio communication device C1. The radio communication devices A1, B1 and D1 have the same configuration.

The radio communication device C1 has an antenna 10, a receiving unit 20, a transmission prevent table storage 30, a prediction unit 40, and a transmitting unit 50. The receiving unit 20 has a frame analyzer 21 and an arrival direction estimation unit 22.

The antenna 10 may be a directional antenna that can transmit the electric wave in a specific direction, and estimate the direction from which the received electric wave arrives, for example, a switch type directional antenna with the same number of switches as the number of sectors, or a rotational adaptive array antenna.

The receiving unit 20 performs a reception process for the electric wave received by the antenna 10 to convert the electric wave into a frame. The receiving unit 20 performs a physical layer relevant process including frequency conversion, low noise amplification, and AD (Analog to Digital) conversion for the received electric wave. The receiving unit 20 performs a demodulation process for the received frame after performing the physical layer relevant process.

The frame analyzer 21 analyzes the received frame obtained by converting the electric wave received by the antenna 10. For example, the frame analyzer 21 reads a MAC (Media Access Control) address of source or MAC address of destination included in a MAC header of the received frame. Also, the frame analyzer 21 reads the period for which the radio channel is occupied by the radio communication device of source of the received frame from a Duration field included in the MAC header of the received frame or a Signal header included in a PHY (Physical Layer) header, for example.

The arrival direction estimation unit 22 estimates the direction from which the electric wave received by the antenna 10 arrives. That is, the arrival direction estimation unit 22 measures the received power for each direction from the first direction to the sixth direction, and estimates the direction having the greatest received power as the direction from which the electric wave arrives. In the embodiment of the invention, a method for estimating the direction from which the electric wave arrives is not limited to the above method.

FIG. 4 is a view showing one example of storage contents of the transmission prevent table storage 30.

The transmission prevent table storage 30 stores a transmission prevent table including the direction of preventing the transmission of electric wave (transmission prevent direction) associated with the period of preventing the transmission of electric wave in that direction (transmission prevent period). The transmission prevent table as shown in FIG. 4 indicates that the transmission of electric wave in the first direction is prevented for 100 μsec, and the transmission of electric wave in the third direction is prevented for 200 μsec.

The prediction unit 40 predicts the direction from which the electric wave arrives in the future at high possibility in accordance with the estimative direction estimated by the arrival direction estimation unit 22. The prediction unit 40 regards the received electric wave as being propagated, and predicts the direction along which the electric wave propagates to the radio communication terminal of destination, namely, the direction along which the electric wave propagates in the future, in accordance with the estimative direction estimated by the arrival direction estimation unit 22.

The transmitting unit 50 performs a process for transmitting the transmission frame, including a DA (Digital to Analog) conversion process, a modulation process, and a frequency conversion process. The transmitting unit 50 reads the transmission prevent table stored in the transmission prevent table storage 30, and transmits the transmission frame by transmitting the electric wave in the direction where the transmission of electric wave is not prevented. That is, the transmitting unit 50 makes the transmission by forming the electric wave (beam) to orient a NULL point in the direction where the transmission of electric wave is prevented. If the transmitting unit 50 cannot form the electric wave to orient the NULL point in the direction where the transmission of electric wave is prevented, the transmission of electric wave is disabled. In the embodiment of the invention, the transmitting unit 50 is not limited to the above operation, but may permit the transmission if the strength of electric wave (beam) transmitted in the direction where the transmission of electric wave is prevented is below a threshold.

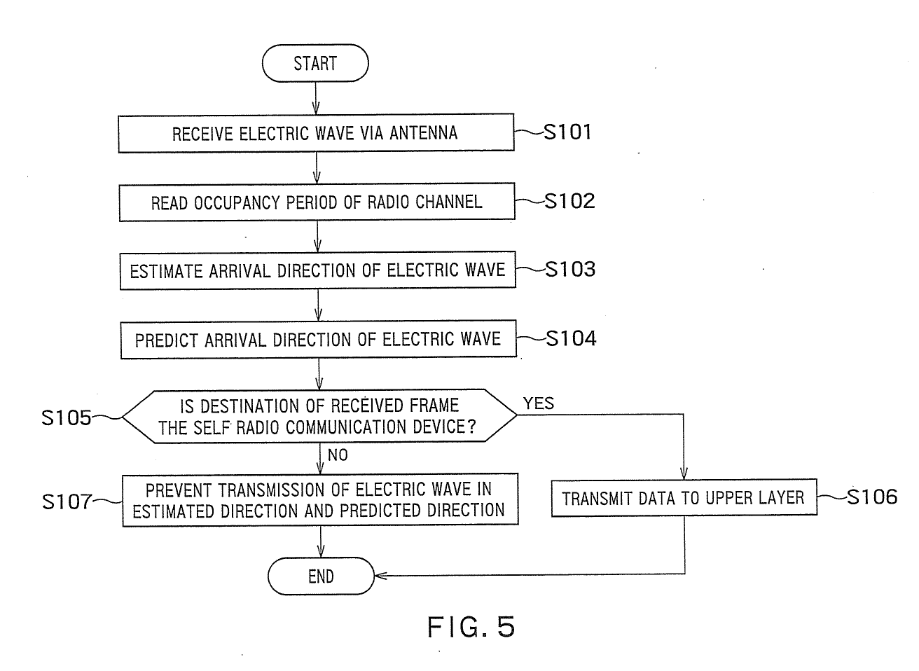

FIG. 5 is a flowchart showing the operation of the radio communication device C1. The radio communication devices A1, B1 and D1 perform the same operation.

First of all, the electric wave is received by the antenna 10 in the radio communication device C1 (step S101). The receiving unit 20 performs a reception process for the electric wave received by the antenna 10 to convert the electric wave into the received frame.

Next, the frame analyzer 21 of the receiving unit 20 reads the period (occupancy period) for which the radio channel is occupied by other radio communication devices (step S102). Herein, the frame analyzer 21 of the receiving unit 20 may have the Duration value included in the MAC header as the occupancy period, or calculate the occupancy period from the size of frame as described in the Signal header included in the PHY header and the transmission rate. The frame analyzer 21 of the receiving unit 20 outputs the read occupancy period to the transmission prevent table storage 30.

Next, the arrival direction estimation unit 22 estimates the direction from which the electric wave corresponding to the received frame arrives (step S103). The arrival direction estimation unit 22 outputs the direction from which the electric wave arrives and the estimated direction (estimative direction) to the prediction unit 40.

Next, the prediction unit 40 predicts the direction from which the electric wave arrives in the future at high possibility or the direction along which the electric wave is propagated in the future in accordance with the estimative direction estimated by the arrival direction estimation unit 22 (step S104). A method for the prediction unit 40 predicting the predictive direction will be described later.

Next, the frame analyzer 21 of the receiving unit 20 determines whether the destination of the received frame is the self radio communication device or the other radio communication device (step S105). That is, the frame analyzer 21 determines whether the received frame is transmitted to the self radio communication device or the other radio communication device, depending on whether or not the MAC address of destination included in the MAC header of the received frame is the same as the MAC address of the self radio communication device.

If the destination of the received frame is the self radio communication device (“YES” at step S105), the receiving unit 20 extracts a data part from the received frame, and outputs the data part to an upper level layer (step S106).

On the other hand, if the destination of the received frame is not the self radio communication device (“NO” at step S105), the occupancy period analyzed by the frame analyzer 21, the estimative direction estimated by the arrival direction estimation unit 22, and the predictive direction outputted from the prediction unit 40 are inputted into the transmission prevent table storage 30. The transmission prevent table storage 30 adds an entry for preventing the transmission of electric wave in the estimative direction for the occupancy period and additionally stores an entry for preventing the transmission of electric wave in the predictive direction for the occupancy period (step S107).

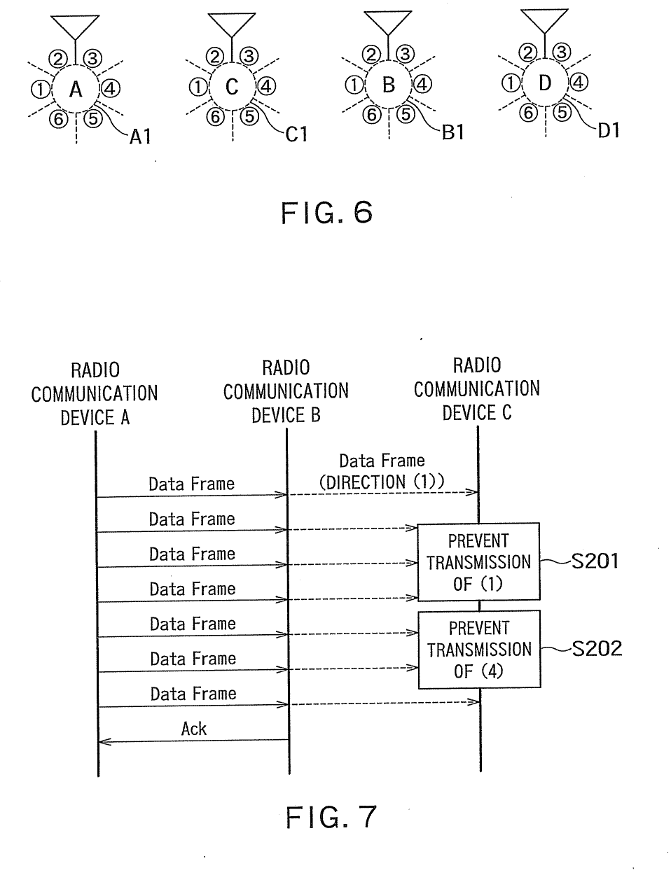

FIG. 6 is a diagram showing the result of moving the radio communication devices A1, B1, C1 and D1 as shown in FIG. 2 and the new positional relationship among the radio communication devices A1, B1, C1 and D1.

The radio communication device C1 exists between the radio communication devices A1 and B1, as shown in FIG. 6. Therefore, the radio communication device C1 receives the electric wave transmitted from the radio communication device A1 to the radio communication device B1 from the first direction, and receives the electric wave transmitted from the radio communication device B1 to the radio communication device A1 from the fourth direction.

FIG. 7 is a diagram showing the frame transmission and reception between the radio communication devices A1, B1 and C1 and the operation in the positional relationship among the radio communication devices A1, B1, C1 and D1 as shown in FIG. 6.

First of all, the radio communication device A1 transmits the frames to the radio communication device B1 by burst transmission, as shown in FIG. 7. Then, the radio communication device B1 returns a response frame (Ack) to the burst transmitted data to the radio communication device A1 after the burst transmission from the radio communication device A1 is completed.

If the radio communication device A1 starts the burst transmission of the frames to the radio communication device B1, the radio communication device C1 receives the electric wave transmitted from the radio communication device A1 to the radio communication device B1 (step S101 in FIG. 5). After the radio communication device C1 receives the frame addressed to the radio communication device B1, the arrival direction estimation unit 22 estimates the arrival direction of electric wave as the first direction (step S103 in FIG. 5), and the prediction unit 40 predicts that the fourth direction opposite to the first direction (in the relationship of 180 degrees to the first direction) is the direction from which the electric wave arrives in the future at high possibility or the direction to which the electric wave propagates in the future (step S104 in FIG. 5). The transmission prevent table storage 30 of the radio communication device C1 newly stores the estimative direction (first direction) estimated by the estimation unit and the predictive direction (fourth direction) predicted by the prediction unit 40 as the direction of preventing the transmission of electric wave (steps S201, S202 in FIG. 7).

Therefore, even if the radio communication device C1 receives only the electric wave arriving from the first direction during the burst transmission of the frames from the radio communication device A1 to the radio communication device B1, there occurs no collision when the radio communication device B1 receives the frames from the radio communication device A1 because the radio communication device C1 prevents the transmission of electric wave in the fourth direction.

Also, even if the radio communication device C1 receives only the electric wave arriving from the first direction during the frame transmission from the radio communication device A1 to the radio communication device B1 in which the response frame is not expected, there occurs no collision when the radio communication device B1 receives the frames from the radio communication device A1, because the radio communication device C1 prevents the transmission of electric wave in the fourth direction.

In this way, with the radio communication device according to the first embodiment, in receiving the frame addressed to the other radio communication device, the transmission of electric wave is prevented in not only the arrival direction of electric wave but also the opposite direction to the arrival direction of electric wave as the direction from which the electric wave arrives in the future at high possibility, whereby the occurrence of collision can be suppressed. Since the occurrence of collision can be suppressed, the total throughput of the radio communication devices A1, B1, C1 and D1 can be improved.

The effect of the radio communication device according to the first embodiment is more remarkable as more radio communication devices are arranged in one row. For example, an ITS (Intelligent Transport System) is employed in the environment where a number of radio communication devices are likely to be arranged in one row, and particularly achieves the effect that the total throughput can be improved by suppressing the occurrence of collision.

The radio communication devices A1, B1, C1 and D1 can be realized by using a general-purpose computer apparatus as the basic hardware. That is, the receiving unit 20, the frame analyzer 21, the arrival direction estimation unit 22, the prediction unit 40 and the transmitting unit 50 can be realized by executing a program using the processor mounted on the computer apparatus. At this time, the radio communication device may be realized by installing beforehand the program into the computer apparatus, or appropriately installing the program into the computer apparatus from a storage medium such as CD-ROM storing the program or via a network to distribute the program. Also, the transmission prevent table storage 30 may be realized by appropriately using the internal or outside memory or hard disk, or the storage medium such as CD-R, CD-RW, DVD-RAM or DVD-R.

### Second Embodiment

In the first embodiment, in the case where the plurality of radio communication devices are arranged in one row, the total throughput can be effectively improved by suppressing the occurrence of collision. Further, even if the plurality of radio communication devices are not arranged in one row, it is desirable that the throughput can be effectively improved by suppressing the occurrence of collision.

Thus, a radio communication device according to a second embodiment further has an arrival direction storage for storing the arrival direction of electric wave transmitted from the first other radio communication device to the second other radio communication device. In the radio communication device according to the second embodiment and the radio communication device according to the first embodiment, the same reference numerals are attached to the same parts (antenna 10, arrival direction estimation unit 22, transmission prevent table storage 30, transmitting unit 50), and the explanation of the same parts is omitted.

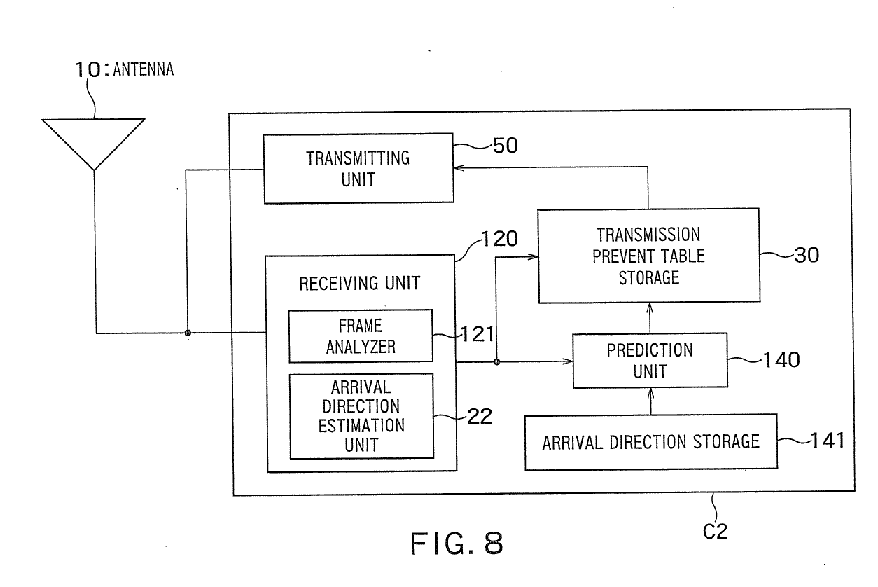

FIG. 8 is a block diagram showing the configuration of the radio communication device C2 according to the second embodiment. The radio communication devices A2, B2 and D2 have the same configuration.

The radio communication device C2 according to the second embodiment further has the arrival direction storage 141 for storing the arrival direction of electric wave transmitted from the first other radio communication device to the second other radio communication device.

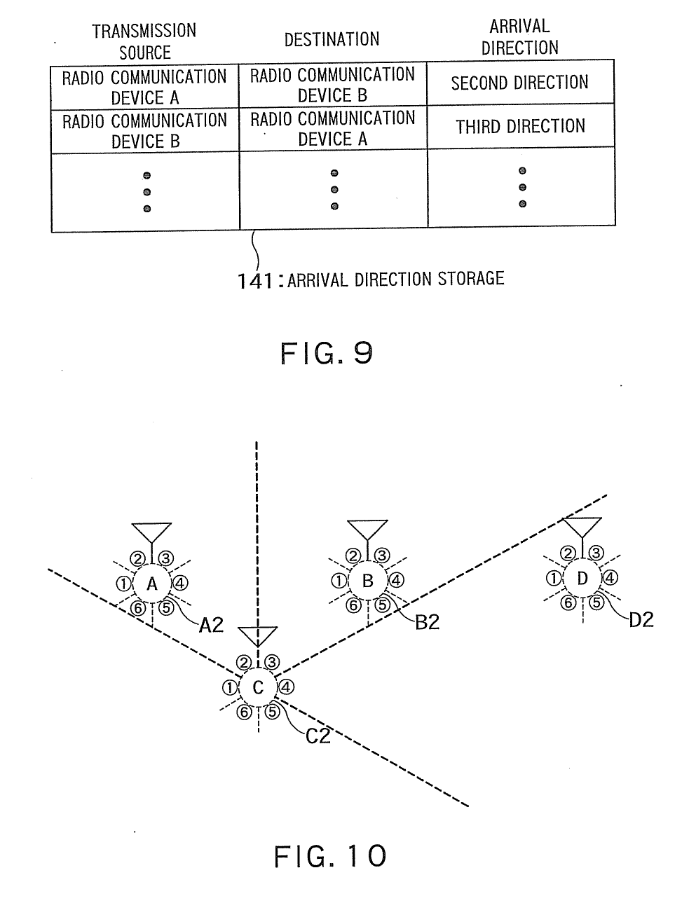

FIG. 9 is a view showing one example of storage contents of the arrival direction storage 141.

The arrival direction storage 141 stores the “arrival direction” from which the electric wave arrives, and the “transmission source” and the “destination” of the electric wave. The arrival direction storage 141 according to the second embodiment prestores the combinations of the “arrival direction” from which the electric wave arrives and the “transmission source” and the “destination” of the electric wave.

The storage contents of the arrival direction storage 141 indicate that the electric wave transmitted from the radio communication device A3 to the radio communication device B3 arrives from the second direction, and the electric wave transmitted from the radio communication device B3 to the radio communication device A3 arrives from the third direction, as shown in FIG. 9.

FIG. 10 is a diagram showing the positional relationship among the radio communication devices A2, B2, C2 and D2.

The radio communication device C2 is located off the row where the radio communication devices A2, B2 and D2 are arranged, and exists between the radio communication devices A2 and B2, as shown in FIG. 10. Therefore, the radio communication device C2 receives the electric wave transmitted from the radio communication device A2 to the radio communication device B2 in the second direction, and receives the electric wave transmitted from the radio communication device B2 to the radio communication device A2 in the third direction.

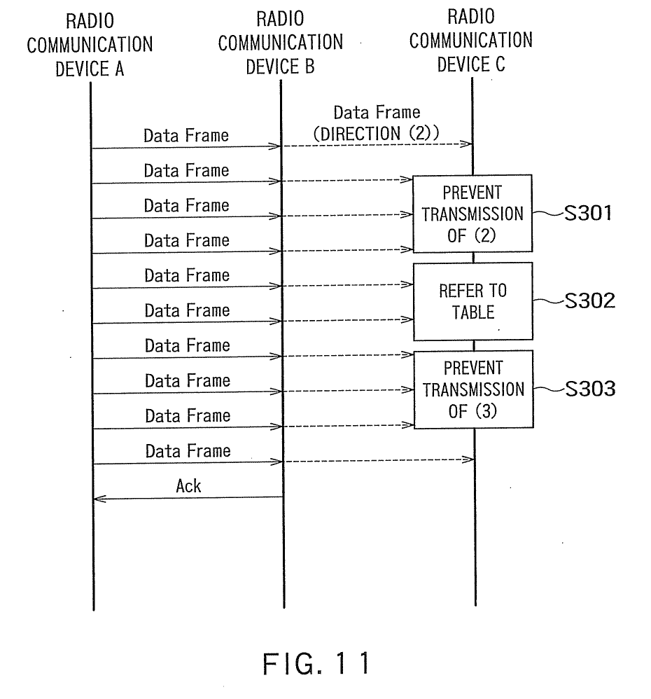

FIG. 11 is a diagram showing the frame transmission and reception between the radio communication devices A2, B2 and C2 and the operation in the positional relationship among the radio communication devices A2, B2, C2 and D2 as shown in FIG. 10. The operation of the radio communication device C2 according to the second embodiment will be described below for different points from the operation of the radio communication device C1 according to the first embodiment, using FIG. 5.

First of all, the radio communication device A2 transmits the frames to the radio communication device B2 by burst transmission, as shown in FIG. 11. Then, the radio communication device B2 returns a response frame (Ack) to the burst transmitted data to the radio communication device A2 after the burst transmission from the radio communication device A2 is completed.

If the radio communication device A2 starts the burst transmission of the frames to the radio communication device B2, the radio communication device C2 firstly receives the electric wave transmitted from the radio communication device A2 to the radio communication device B2 (step S101 in FIG. 5).

Next, a frame analyzer 121 of the radio communication device C2 reads the occupancy period of the radio channel as described in the frame received by the electric wave (step S102 in FIG. 5).

Next, the arrival direction estimation unit 141 of the radio communication device C2 estimates the direction of receiving the frame as the second direction and outputs the estimative direction (second direction) to the transmission prevent table storage 30 (step S103 in FIG. 5, step S301 in FIG. 11).

Next, a prediction unit 140 notifies the destination and transmission source of the received frame, and reads the arrival direction (third direction) of electric wave transmitted from the radio communication device 132 of destination of the received frame to the radio communication device A3 of transmission source of the received frame from the arrival direction storage 141 to make the third direction the predictive direction (step S104 in FIG. 5, step S302 in FIG. 11).

Next, the prediction unit 140 stores the third direction read from the arrival direction storage 141 as the direction of preventing the transmission of electric wave in the transmission prevent table storage 30 (step S107 in FIG. 5, step S303 in FIG. 11).

In this way, the estimative direction (second direction) of the arrival direction estimation unit 22 and the predictive direction (third direction) of the prediction unit 140 are newly stored as the direction of preventing the transmission of electric wave in the transmission prevent table storage 30 of the radio communication device C2 (step S301, S303 in FIG. 11).

Therefore, even if the radio communication device C2 receives only the electric wave arriving from the second direction during the burst transmission of the frames from the radio communication device A2 to the radio communication device B2, there occurs no collision because the radio communication device C2 prevents the transmission of electric wave in the third direction.

Also, even if the radio communication device C2 receives only the electric wave arriving from the second direction during the frame transmission in which the response frame from the radio communication device A2 to the radio communication device B2 is not expected, there occurs no collision because the radio communication device C2 prevents the transmission of electric wave in the third direction.

In this way, with the radio communication device according to the second embodiment, in receiving the frame addressed to the other radio communication device, the transmission of electric wave is prevented in not only the arrival direction of electric wave, but also the read arrival direction of electric wave transmitted from the radio communication device of destination of the frame to the radio communication device of transmission source of the frame, which is read from the arrival direction storage 141, whereby even if the radio communication devices are not arranged in one row, the occurrence of collision can be suppressed. Since the occurrence of collision can be suppressed, the total throughput of the radio communication devices A2, B2, C2 and D2 can be improved.

Though in the second embodiment, the arrival direction storage 141 stores the “transmission source”, the “destination”, and the “arrival direction” from which the electric wave arrives, when the electric wave is transmitted from the radio communication device of “transmission source” to the radio communication device other than the self radio communication device, it may store the combination of two terminals making the communication and the arrival direction of electric wave when the communication is performed.

In such a case, the arrival direction storage 141 stores the arrival direction of electric wave transmitted when the bidirectional radio communication is made between the radio communication device A2 and the radio communication device B2, namely, the second direction and the third direction. And in receiving the electric wave transmitted from the radio communication device A2 to the radio communication device B2 in the second direction, the prediction unit 140 predicts the arrival direction of electric wave transmitted when the radio communication is performed between the radio communication device A2 and the radio communication device B2, in which the electric wave does not yet arrive, namely, the third direction, and stores the second direction and the third direction as the direction of preventing the transmission of electric wave in the transmission prevent table storage 30.

Also, in the second embodiment, the arrival direction storage 141 prestores the “transmission source”, “destination” and “arrival direction” from which the electric wave arrives, when the electric wave is transmitted from the radio communication device of “transmission source” to the radio communication device of “destination”.

However, if the storage content of the arrival direction storage 141 is different from the storage content already stored in the arrival direction storage 141, for example, when the electric wave transmitted from the radio communication device A2 to the radio communication device B2 is received from the first direction, the storage content of the arrival direction storage 141 can be updated.

Further, if the “arrival direction” from which the electric wave arrives is not stored in the arrival direction storage 141 in transmitting the electric wave from the radio communication device of “transmission source” to the radio communication device of “destination”, for example, when the electric wave transmitted from the radio communication device D2 to the radio communication device A2 is received from the fourth direction, the storage content of the arrival direction storage 141 can be added.

In this way, information on the arrival direction of electric wave transmitted from the first other radio communication device to the second other radio communication device can be maintained in the latest condition by receiving the electric wave transmitted and received between other radio communication devices, whereby the occurrence of collision can be suppressed at higher precision.

### Third Embodiment

In the first embodiment, in receiving the frame addressed to the other radio communication device, the transmission of electric wave is prevented in not only the arrival direction of electric wave, but also the direction in which the destination terminal of the electric wave exists at high possibility, whereby the total throughput can be effectively improved by suppressing the occurrence of collision. Further, even if the direction from which the electric wave arrives in the future at high possibility is predicted incorrectly, it is desirable that the incorrectness is modified promptly, and the throughput can be effectively improved by suppressing the occurrence of collision.

Thus, the radio communication device according to the third embodiment further has a cancel unit for canceling the transmission prevent of electric wave in the predictive direction predicted by the prediction unit among the entries stored in the transmission prevent table. In the radio communication device C3 according to the third embodiment and the radio communication device C1 according to the first embodiment, the same reference numerals are attached to the same parts (antenna 10, arrival direction estimation unit 22, transmission prevent table storage 30, prediction unit 40 and transmitting unit 50), and the explanation of the same parts is omitted. The positional relationship among the radio communication devices A3, B3, C3 and D3 is the same as the positional relationship among the communication devices A2, B2, C2 and D2 as shown in FIG. 10.

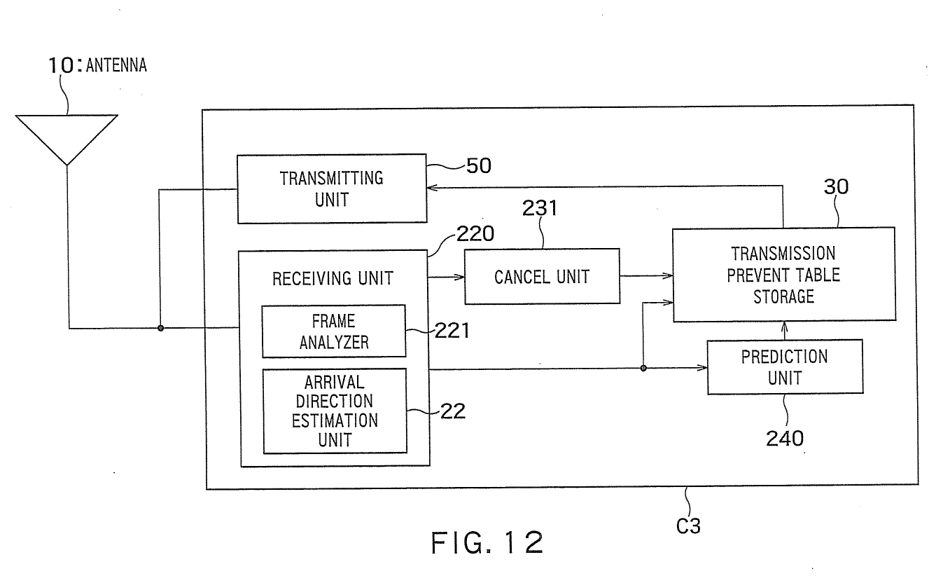

FIG. 12 is a block diagram showing the configuration of the radio communication device C3 according to the third embodiment. The radio communication devices A3, B3 and D3 have the same configuration.

The radio communication device according to the third embodiment further has the cancel unit 231 for canceling the transmission prevent of electric wave in the predictive direction predicted by the prediction unit 40.

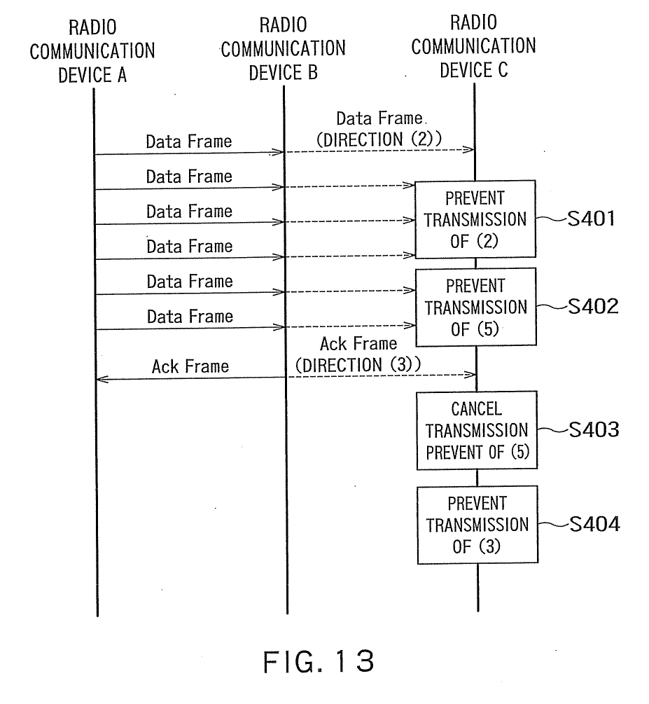

FIG. 13 is a diagram showing the frame transmission and reception between the radio communication devices A3, B3 and C3 and the operation in the positional relationship among the radio communication devices A3, B3, C3 and D3 as shown in FIG. 10. The operation of the radio communication device C3 according to the third embodiment will be described below for different points from the operation of the radio communication device C1 according to the first embodiment, using FIG. 5.

First of all, the radio communication device A3 transmits the frames to the radio communication device B3 by burst transmission, as shown in FIG. 13. Next, the radio communication device B3 returns a response frame (Ack) to the burst transmitted data to the radio communication device A3 after the burst transmission from the radio communication device A3 is completed.

If the radio communication device A3 starts the burst transmission of the frames to the radio communication device B3, the radio communication device C3 firstly receives the electric wave transmitted from the other radio communication device A3 to the other radio communication device B3 (step S101 in FIG. 5).

Next, a frame analyzer 221 of the radio communication device C3 reads the occupancy period of the radio channel as described in the frame received by the electric wave (step S102 in FIG. 5).

Next, the arrival direction estimation unit 22 of the radio communication device C3 estimates the direction of receiving the frame as the second direction and outputs the estimative direction (second direction) to the transmission prevent table storage 30 (step S103 in FIG. 5, step S401 in FIG. 13).

Next, the prediction unit 40 predicts the fifth direction opposite to the estimative direction (second direction) (in the relationship of 180 degrees to the first direction) as the direction from which the electric wave arrives in the future at high possibility (step S104 in FIG. 5, step S402 in FIG. 13). That is, the prediction unit 40 stores the fifth direction as the direction of preventing the transmission of electric wave in the transmission prevent table storage 30.

In this way, the estimative direction (second direction) of the arrival direction estimation unit 22 and the predictive direction (fifth direction) of the prediction unit 40 are newly stored as the direction of preventing the transmission of electric wave in the transmission prevent table storage 30 of the radio communication device C3. Also, the period of preventing the transmission of electric wave in the second direction and the fifth direction is the period (occupancy period) for which the radio channel is continuously occupied by the other radio communication devices A3, B3 as described in the frame.

Herein, after preventing the transmission of electric wave in the estimative direction and the predictive direction, and before the occupancy period passes, if the electric wave transmitted from the radio communication device 133 to the radio communication device A3 is received in the other direction (e.g., third direction) than the predictive direction, the cancel unit 231 of the radio communication device C3 cancels the transmission prevent of electric wave in the predictive direction (fifth direction) of the prediction unit 40 as the prediction of the prediction unit 40 is mistaken (step S403 in FIG. 13), and newly prevents the transmission of electric wave in the third direction (step S404 in FIG. 13). The prediction unit 40 sets the transmission prevent period of electric wave in the third direction to be the same as the transmission prevent period of electric wave in the predictive direction (fifth direction) of the prediction unit 40. The prediction unit 40 may set the transmission prevent period of electric wave in the third direction to be the same as the occupancy period decided according to the frame received from the third direction.

In this way, if the direction from which the electric wave arrives in the future at high possibility is predicted incorrectly by the prediction unit 40, the error is modified promptly, whereby there is no occurrence of collision, because the radio communication device C3 prevents the transmission of electric wave in the third direction even though the frame is transmitted from the radio communication device B3 to the radio communication device A3.

In this way, with the radio communication device according to the third embodiment, in receiving the frame addressed to the other radio communication device, the transmission of electric wave is prevented in not only the arrival direction of electric wave, but also the direction from which the electric wave arrives in the future at high possibility, and even if the prediction result (direction from which the electric wave arrives in the future at high possibility) is incorrect, the direction of preventing the transmission is modified promptly, whereby the occurrence of collision can be suppressed. Further, since the occurrence of collision can be suppressed, the total throughput of the radio communication devices A3, B3, C3 and D3 can be improved.

In the third embodiment, after preventing the transmission of electric wave in the estimative direction and the predictive direction, and before the occupancy period passes, if the electric wave transmitted from the radio communication device B3 to the radio communication device A3 is received in the different direction from the predictive direction, the cancel unit 231 cancels the transmission prevent of electric wave in the predictive direction (fifth direction) of the prediction unit 40 as the prediction of the prediction unit 40 is mistaken, and newly prevents the transmission of electric wave in the direction from which the electric wave arrives.

However, after preventing the transmission of electric wave in the estimative direction and the predictive direction, and before the occupancy period passes, if the response frame (ACK, or CTS (Clear To Send)) transmitted from the radio communication device B3 to the radio communication device A3 is received in the different direction from the predictive direction, the cancel unit 231 can cancel the transmission prevent of electric wave in the predictive direction (fifth direction) of the prediction unit 40 as the prediction of the prediction unit 40 is mistaken, and newly prevent the transmission of electric wave in the direction from which the electric wave arrives.

In this way, it is possible to determine whether or not the predictive direction of the prediction unit 40 is incorrect more accurately.

Also, in the third embodiment, before the period of preventing the transmission of electric wave is ended, if the frame transmitted from the radio communication device B3 to the radio communication device A3 is received in the different direction from the predictive direction, the cancel unit 231 can cancel the transmission prevent of electric wave in the predictive direction of the prediction unit 40 as the prediction of the prediction unit 40 is mistaken, and newly prevent the transmission of electric wave in the direction from which the electric wave arrives.

Moreover, in the third embodiment, if the frame transmitted from the radio communication device B3 to the radio communication device A3 is received in the different direction from the predictive direction within a response frame transmission period of the frame addressed to the other radio communication device, the cancel unit 231 can cancel the transmission prevent of electric wave in the predictive direction of the prediction unit 40 as the prediction of the prediction unit 40 is mistaken, and newly prevent the transmission of electric wave in the direction from which the electric wave arrives.

Also, though the prediction unit 40 predicts the opposite direction to the estimative direction as the predictive direction in the third embodiment, the predictive direction may be decided according to the storage contents stored in the arrival direction storage 141 by further including the arrival direction storage 141 as described in the second embodiment.

### Fourth Embodiment

In the first embodiment, the transmission of electric wave is prevented for every direction from which the electric wave arrives in the future at high possibility, using the electric wave transmitted to make the radio communication between other radio communication devices, whereby the total throughput can be effectively improved by suppressing the occurrence of collision. Further, it is desirable that the transmission of electric wave in the direction from which the electric wave arrives in the future at high possibility can be made using information on the frame transmitted by the self radio communication device.

Thus, though the radio communication device according to the fourth embodiment further has an prevent unit for preventing the transmission of electric wave in a specific direction if a response request frame is transmitted by transmitting the electric wave in the specific direction, but a response frame to the response request frame cannot be received. In the radio communication device according to the fourth embodiment and the radio communication device according to the first embodiment, the same reference numerals are attached to the same parts (antenna 10, arrival direction estimation unit 22, transmission prevent table storage 30 and prediction unit 40), and the explanation of the same parts is omitted. The positional relationship among the radio communication devices A4, B4, C4 and D4 is the same as the positional relationship among the communication devices A2, B2, C2 and D2 as shown in FIG. 10.

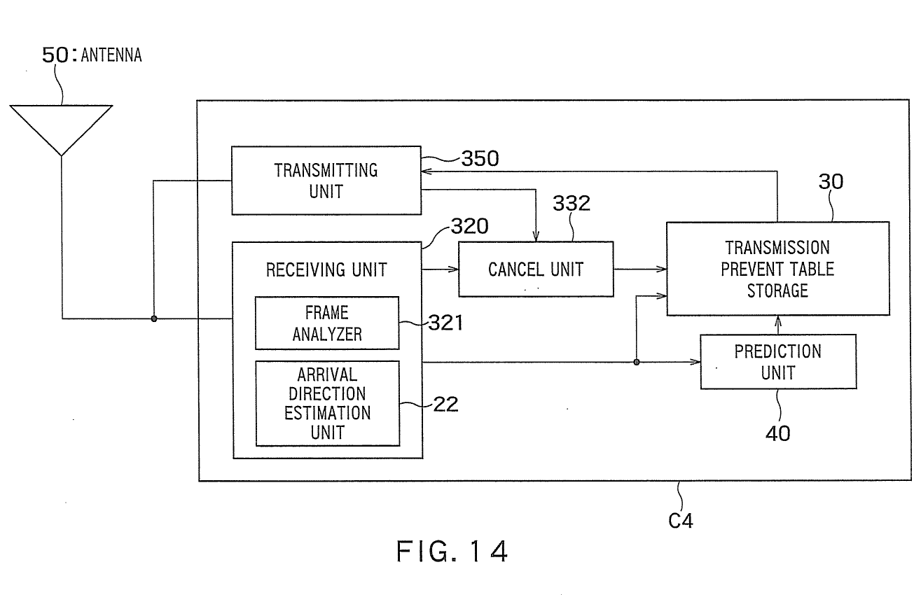

FIG. 14 is a block diagram showing the configuration of the radio communication device C4 according to the fourth embodiment. The radio communication devices A4, B4 and D4 have the same configuration.

The radio communication device C4 according to the fourth embodiment further has the prevent unit 332 for preventing the transmission of electric wave in a specific direction if a response request frame is transmitted by transmitting the electric wave in the specific direction, but a response frame to the response request frame cannot be received.

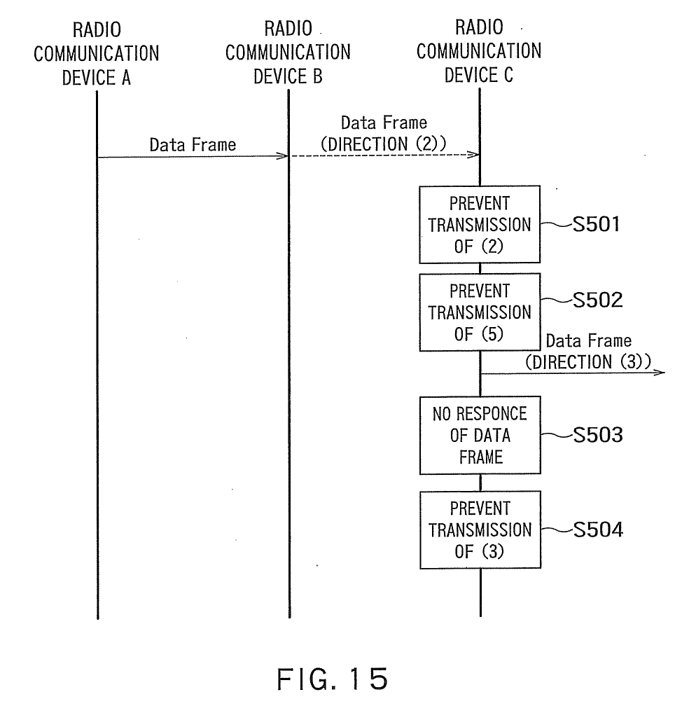

FIG. 15 is a diagram showing the frame transmission and reception between the radio communication devices A4, B4 and C4 and the operation in the positional relationship among the radio communication devices A4, B4, C4 and D4 as shown in FIG. 9. The operation of the radio communication device C4 according to the fourth embodiment will be described below for different points from the operation of the radio communication device C1 according to the first embodiment, using FIG. 5.

First of all, the radio communication device A4 transmits the frame to which any response frame is not expected to the radio communication device B4 as shown in FIG. 15.

The radio communication device C4 receives the frame transmitted from the radio communication device A4 to the radio communication device B4 (step S101 in FIG. 5).

Next, the arrival direction estimation unit 22 of the radio communication device C4 estimates the second direction as the direction from which the electric wave arrives (step S103 in FIG. 5, step 5501 in FIG. 15).

Also, the prediction unit 40 predicts the fifth direction opposite to the second direction as the direction from which the electric wave arrives in the future at high possibility (step S104 in FIG. 5, step S502 in FIG. 15).

In this way, the estimative direction (second direction) of the arrival direction estimation unit 22 and the predictive direction (fifth direction) of the prediction unit 40 are newly stored as the direction of preventing the transmission of electric wave in the transmission prevent table storage 30 of the radio communication device C4. Also, the period of preventing the transmission of electric wave in the second direction and the fifth direction is the period for which the radio channel is continuously occupied by the other radio communication devices A4, B4 as described in the frame (occupancy period).

Herein, if a transmitting unit 350 of the radio communication device C4 transmits a response request frame to the radio communication device D4 by transmitting the electric wave in the fourth direction, but the response frame cannot be received within a predetermined response time, that is, a frame analyzer 321 does not transmit a notice that the response frame is received within the predetermined response to the prevent unit 332, the prevent unit 332 of the radio communication device C4 adds the fourth direction to the transmission prevent direction of the transmission prevent table to prevent the transmission of electric wave in the fourth direction.

The response request frame transmitted by the transmitting unit 350 may be the frame to which the radio communication device of destination receiving the response request frame transmits the response frame within the predetermined response period. An example of the response request frame is an RTS (Request To Send), to which the response frame is a CTS (Clear To Send). Also, another example of the response request frame transmitted by the transmitting unit 350 is a data frame that expects Ack, to which the response frame is an Ack frame.

When the radio communication device C4 transmits the electric wave, as a result of carrier sense for a DIFS (Distributed Inter Frame Spacing) period on the radio channel for transmitting the electric wave in the receiving unit 320, if the radio channel is judged as IDLE, the radio communication device waits for a Backoff period and then transmits the electric wave.

Herein, the prevent unit 332 of the radio communication device C4 has the transmission prevent period for the fourth direction as the transmission prevent period for the other direction in the transmission prevent table. If the transmission prevent table includes multiple directions of preventing the transmission of electric wave, the prevent unit 332 of the radio communication device C4 has the longest transmission prevent period among the transmission prevent periods for the multiple transmission prevent directions as the transmission prevent period for the fourth direction.

The prevent unit 332 of the radio communication device C4 may have the transmission prevent period for the adjacent direction (third direction or fifth direction) to the fourth direction as the transmission prevent period for the fourth direction. Also, the prevent unit 332 of the radio communication device C4 may have the time required to transmit or receive the frame having the largest size among the frames for which the receiving unit 320 and the transmitting unit 350 make the radio communication as the transmission prevent period for the fourth direction.

In this way, if the response request frame is transmitted by transmitting the electric wave in a predetermined direction, but the response frame cannot be received within the predetermined response time, that is, it is expected that there occurs collision with the frame of another radio communication device, the radio communication between other radio communication devices is not obstructed by preventing the transmission of electric wave in the predetermined direction where the collision is expected to occur.

In this way, with the radio communication device according to the fourth embodiment, the transmission of electric wave in the direction in which the collision is expected to occur is prevented, whereby the occurrence of collision to obstruct the radio communication between other radio communication devices can be suppressed. Since the occurrence of collision is suppressed, the total throughput of the radio communication devices A4, B4, C4 and D4 can be improved.

1. A radio communication device communicating by using an antenna, comprising:
an estimation unit configured to estimate a first direction from which a first electric wave has arrived;
a conversion unit configured to convert the first electric wave into a first frame;
a determination unit configured to determine whether or not a destination of the first frame is the radio communication device;
a first prevent unit configured to prevent transmission of electric wave in the first direction when it is determined that the destination of the first frame is a second radio communication device;
a prediction unit configured to predict a second direction from which a second electric wave arrives before a second frame is transmitted with the second electric wave from the second radio communication device which is a destination of the first frame to a first radio communication device which is a source of the first frame; and
a second prevent unit configured to prevent transmission of electric wave in the second direction.

2. The device according to claim 1, wherein
the first prevent unit prevents the transmission of electric wave in the first direction only for a first prevent period decided based on an occupancy period of a radio channel as described in the first frame, and
the second prevent unit prevents the transmission of electric wave in the second direction only for a second prevent period decided based on the occupancy period of the radio channel as described in the first frame.

3. The device according to claim 1, wherein the prediction unit predicts an opposite direction to the first direction as the second direction.

4. The device according to claim 1, further comprising:
a first storage configured to store a direction from which electric wave transmitted from the first radio communication device to the second radio communication device arrives; and
a second storage configured to store a direction from which electric wave transmitted from the second radio communication device to the first radio communication device arrives,
wherein in receiving the first frame, the prediction unit reads the direction from which the electric wave transmitted from the second radio communication device to the first radio communication device arrives from the second storage, and predicts the direction read from the second storage as the second direction.

5. The device according to claim 4, further comprising
an update unit configured to update the direction stored in the first storage to the first direction when the first direction from which the first electric wave arrives, estimated by the estimation unit, is different from the direction stored in the first storage in receiving the first frame.

6. The device according to claim 1, further comprising
a third storage configured to store a transmission prevent table that includes a direction of preventing transmission of electric wave associated with a period of preventing the transmission of electric wave in the direction.

7. The device according to claim 6, wherein a result of virtual carrier sense is set to be busy with another radio communication device for the direction of preventing the transmission of electric wave included in the transmission prevent table.

8. The device according to claim 6, wherein
the antenna is a directional antenna composed of a plurality of antenna terminals, which transmits electric wave by forming a directional beam with NULL oriented in a direction that is the direction of preventing the transmission of electric wave in the transmission prevent table.

9. The device according to claim 2, further comprising:
a first cancel unit configured to cancel the transmission prevent of electric wave in the second direction when
the second electric wave is received from any other direction than the second direction since the second prevent unit prevents the transmission of electric wave in the second direction until the transmission prevent of the electric wave is canceled and
a source of frame transmitted by the second electric wave is the second radio communication device and a destination of the frame is the first radio communication device; and
a third prevent unit configured to prevent the transmission of electric wave in the direction of receiving the second electric wave.

10. The device according to claim 2, further comprising:
a first cancel unit configured to cancel the transmission prevent of electric wave in the second direction when
the second electric wave is received from any other direction than the second direction within a response period of the first frame since the second prevent unit prevents the transmission of electric wave in the second direction, and
a source of frame transmitted by the second electric wave is the second radio communication device and a destination of frame is the first radio communication device; and
a third prevent unit configured to prevent the transmission of electric wave in the direction of receiving the second electric wave.

11. The device according to claim 9, further comprising
a second conversion unit configured to convert the second electric wave received from any other direction than the second direction into the second frame,
wherein when the second frame is a response frame to the first frame, the first cancel unit cancels the transmission prevent of electric wave in the second direction.

12. The device according to claim 2, wherein
the second prevent unit prevents transmission of electric wave in all directions, and
the device further comprises a second cancel unit configured to cancel the transmission prevent of electric wave in any other direction than the second direction in receiving the second electric wave within the occupancy period of the radio channel as described in the first frame since the second prevent unit prevents the transmission of electric wave in all directions.

13. The device according to claim 2, wherein
the second prevent unit prevents transmission of electric wave in all directions, and
the device further comprises a second cancel unit configured to cancel the transmission prevent of electric wave in any other direction than the second direction in receiving the second electric wave within a response period of the first frame since the second prevent unit prevents the transmission of electric wave in all directions.

14. The device according to claim 1, further comprising:
a transmission unit configured to transmit a real time response demand frame in the direction where the transmission of electric wave is not prevented; and
a fourth prevent unit configured to prevent the transmission of electric wave in the direction where the transmission unit transmits the electric wave when a response frame to the real time response demand frame cannot be received.

15. The device according to claim 14, wherein when the transmission of electric wave is prevented in any other direction than the direction where the transmission of electric wave is prevented by the fourth prevent unit, the fourth prevent unit has a period for which the transmission of electric wave in the other direction is prevented as a period of preventing the transmission of electric wave.

16. The device according to claim 15, wherein when the transmission of electric wave is prevented in a plurality of other directions than the direction where the transmission of electric wave is prevented by the fourth prevent unit, the fourth prevent unit has a longest period of the periods for which the transmission of electric wave in the plurality of other directions is prevented as the period of preventing the transmission of electric wave.

17. The device according to claim 14, wherein when the transmission of electric wave is prevented in a direction adjacent to the direction where the transmission of electric wave is prevented by the fourth prevent unit, the fourth prevent unit has a period for which the transmission of electric wave in the adjacent direction is prevented as the period of preventing the transmission of electric wave.

18. The device according to claim 14, wherein the fourth prevent unit has time required to transmit the frame of a largest size as the period of preventing the transmission of electric wave.

19. A control method for a radio communication device equipped with an antenna, comprising:
estimating a first direction from which a first electric wave has arrived;
converting the first electric wave into a first frame;
determining whether or not a destination of the first frame is the radio communication device;
preventing transmission of electric wave in the first direction when it is determined that the destination of the first frame is a second radio communication device;
predicting a second direction from which a second electric wave arrives before a second frame is transmitted with the second electric wave from the second radio communication device which is a destination of the first frame to a first radio communication device which is a source of the first frame; and
preventing transmission of electric wave in the second direction.

20. A program storage medium storing a computer program for causing a radio communication device equipped with an antenna to execute instructions to perform the steps of:
estimating a first direction from which a first electric wave has arrived;
converting the first electric wave into a first frame;
determining whether or not a destination of the first frame is the radio communication device;
preventing transmission of electric wave in the first direction when it is determined that the destination of the first frame is a second radio communication device;
predicting a second direction from which a second electric wave arrives before a second frame is transmitted with the second electric wave from the second radio communication device which is a destination of the first frame to a first radio communication device which is a source of the first frame; and
preventing transmission of electric wave in the second direction.
